(19) United States
(12) Patent Application Publication
(10) Pub. No.: US 2014/0167310 A1
(43) Pub. Date: Jun. 19, 2014

(54) PROCESS FOR FORMING CONTAINER BLANK

(71) Applicant: Berry Plastics Corporation, Evansville, IN (US)

(72) Inventors: John B. Euler, Evansville, IN (US); Chris K. Leser, Evansville, IN (US); Jason J. Paladino, Newburgh, IN (US)

(21) Appl. No.: 14/106,276

(22) Filed: Dec. 13, 2013

Related U.S. Application Data
(60) Provisional application No. 61/737,222, filed on Dec. 14, 2012.

(51) Int. Cl. B29B 11/12

(52) U.S. Cl. CPC B29B 11/12
USPC 264/132; 264/153

(57) ABSTRACT

A blank is used to form at least a portion of a container. A process for forming the blank includes several steps such as providing a sheet of material and cutting the sheet of material to establish the blank and scrap.

PRIORITY CLAIM

This application claims priority under 35 U.S.C. §119(e) to U.S. Provisional Application Ser. No. 61/737,222, filed Dec. 14, 2012, which is expressly incorporated by reference herein.

### BACKGROUND

The present disclosure relates to vessels, and in particular to insulated containers, such as cups, for containing hot or cold beverages or food. More particularly, the present disclosure relates to an insulated cup formed from polymeric materials.

### SUMMARY

A vessel in accordance with the present disclosure is established using a blank. The blanks is formed by a blank-forming process that includes the steps of providing a sheet of material and cutting the sheet of material to form the blank and scrap.

In illustrative embodiments, a blank-forming process includes the steps of providing a sheet including an insulative cellular non-aromatic polymeric material and applying localized pressure to at least one area of the sheet to cause the at least one area to be plastically deformed such that the at least one area takes on a permanent set so that a blank and scrap are established.

In illustrative embodiments, the applying step includes providing a heated die having a temperature of between about 225 degrees Fahrenheit and about 325 degrees Fahrenheit and applying pressure to the blank for a dwell time with the heated die. The dwell time is about 0.1 seconds to about 0.2 seconds.

In illustrative embodiments, the blank-forming process further includes the step of decurling the sheet prior to the applying step. The decurling step includes heating the sheet to a temperature of between about 140 degrees Fahrenheit to about 190 degrees Fahrenheit.

In illustrative embodiments, the insulative cellular non-aromatic polymeric material includes a base resin having a high melt strength, a polypropylene copolymer, and a cell forming agent. The base resin comprises broadly distributed molecular weight polypropylene and the broadly distributed molecular weight polypropylene is characterized by a molecular weight distribution that is unimodal.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a plan view of a body blank used to form a body of an insulative cup shown in FIG. 2 suggesting that the body blank is formed from a substrate and that during a blank forming process an embossing device compresses a portion of the body blank along an arcuate fold line and compresses another portion of the body blank between the arcuate fold line and a lower arcuate edge to form a series of spaced-apart depressions that extend between the arcuate fold line and lower arcuate edge;

FIG. 2 is a front elevation view of the insulative cup showing that the insulative cup includes, from top to bottom, the body including a rolled brim, a side wall, and a floor mount and a floor configured to mate with the mount and showing that the series of spaced-apart depressions are formed in the floor mount;

FIG. 3 is a diagrammatic view of a sequence of operations in which a sheet of material is first formed, a blank is formed from the sheet of material, and an article is then formed from the blank;

FIG. 4 is a diagrammatic view of a blank forming process included in the blank forming operation of FIG. 3 showing that the blank forming process includes a preparation stage, a fabrication stage, and a collection stage and suggesting that the preparation stage is completed before the fabrication stage and the fabrication stage is completed before the collection stage;

FIG. 5 is a diagrammatic view of the preparation stage of FIG. 4 showing that the preparation stage includes a roll loading step, an unwinding step, and a de-curling step and suggesting that the roll loading step is completed before the unwinding step and the unwinding step is completed before the de-curling step;

FIG. 6 is a diagrammatic view of the fabrication stage of FIG. 4 showing that the fabrication stage includes a registration control step, an embossing step, and a die cutting step and suggesting that the registration control step is completed before the embossing step and the embossing step is completed before the die cutting step; and

FIG. 7 is a diagrammatic view of the collection stage of FIG. 4 showing that the collection stage includes a blank accumulating step and a scrap collecting step and suggesting that the blank accumulating step is completed before the scrap collecting step.

### DETAILED DESCRIPTION

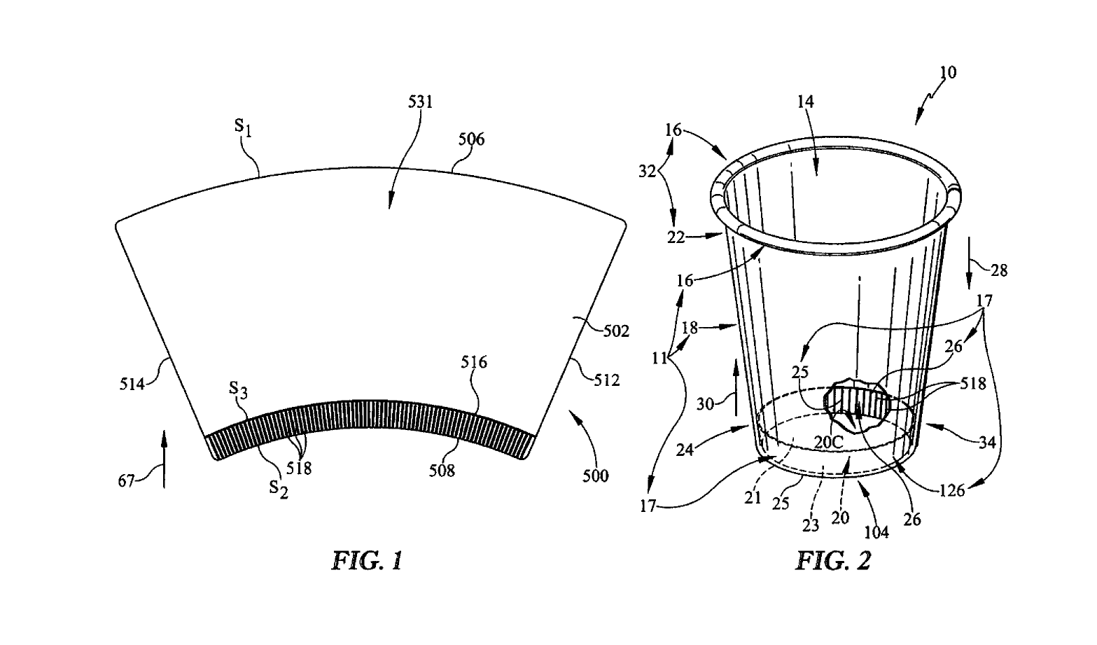

A blank-forming process in accordance with the present disclosure uses a sheet formed from material that is configured to deform plastically in at least one selected region to provide a plastically deformed material segment having a first density and a non-deformed material segment having a second density lower than the first density. The sheet may be formed from insulative cellular non-aromatic polymeric material that is configured to withstand plastic deformation without fracturing so that a predetermined insulative characteristic of the material is maintained. However, the sheet may be formed from insulative cellular aromatic polymeric material or any other suitable alternative. As an example, a body blank 500 is made from a sheet formed from insulative cellular non-aromatic polymeric material as shown in FIG. 1. Body blank 500 is used to form an insulative cup as shown in FIG. 2.

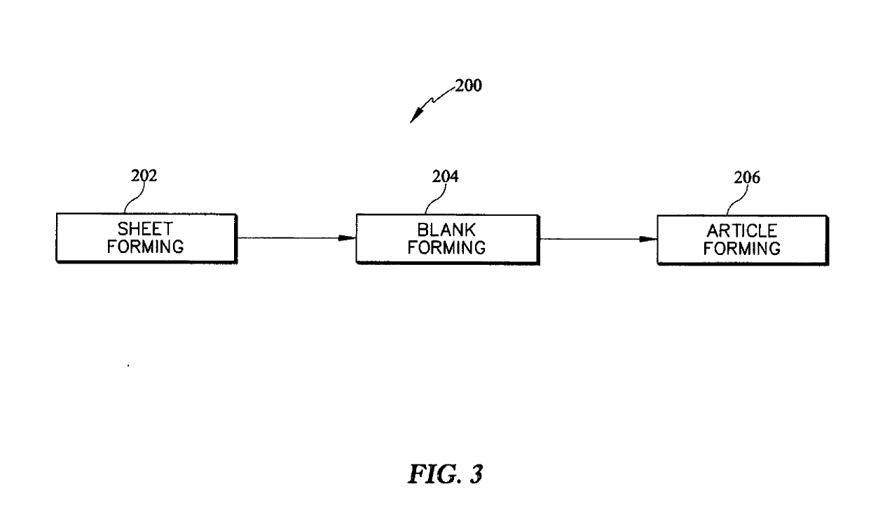

Body blank 500 is made from a sheet comprising insulative cellular non-aromatic polymeric material that is formed in a sheet forming operation as shown in FIG. 3. The sheet may be a single layer sheet that is formed from a single layer of insulative cellular non-aromatic polymeric material configured to display artwork and text. The sheet may also be a multi-layer sheet that includes a substrate layer formed from a single layer of insulative cellular non-aromatic polymeric material and an outer skin layer that is coupled to the substrate layer and configured to display artwork and text.

Vessels such as insulative cup 10 are examples of articles that may be constructed in an article forming operation as shown in FIG. 3 using body blanks formed in the blank forming process in accordance with the present disclosure. Other examples include drink cups, food-storage cups, and dessert cups having insulative qualities suitable for holding hot and cold contents.

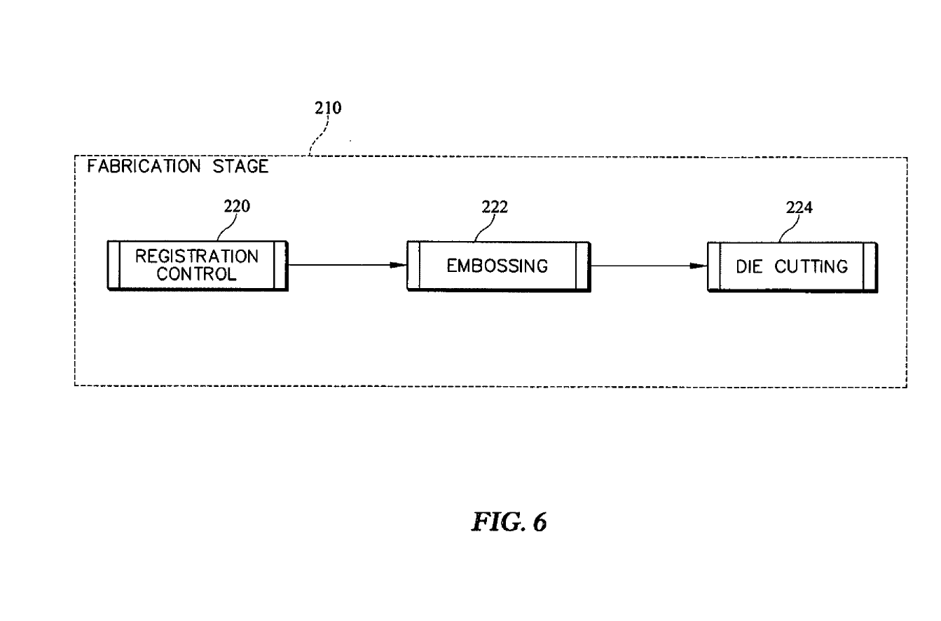

Localized plastic deformation is provided in accordance with the present disclosure in, for example, a floor region 104 of a body 11 of an insulative cup 10 comprising an insulative cellular non-aromatic polymeric material as suggested in FIGS. 1-7. A material has been plastically deformed, for example, when it has changed shape to take on a permanent set in response to exposure to an external compression load and remains in that new shape after the load has been removed. Insulative cup 10 disclosed herein is not a paper cup but rather a cup made of a cellular non-aromatic polymeric material with insulative qualities suitable for holding hot and cold contents.

A first embodiment of insulative cup 10 having region 104 where localized plastic deformation provides segments of insulative cup 10 that exhibit higher material density than neighboring segments of insulative cup 10 in accordance with the present disclosure is shown in FIG. 2. As an example, insulative cup 10 is made using an illustrative body blank 500 as shown in FIG. 1.

Insulative cup 10 comprises a body 11 including a sleeve-shaped side wall 18 and a floor 20 coupled to body 11 to define an interior region 14 bound by sleeve-shaped side wall 18 and floor 20 as shown, for example, in FIG. 2. Body 11 further includes a rolled brim 16 coupled to an upper end of side wall 18 and a floor mount 17 coupled to a lower end of side wall 18.

Body 11 is formed from blank 500 which comprises a strip of insulative cellular non-aromatic polymeric material that is configured (by application of pressure—with or without application of heat) to provide means for enabling localized plastic deformation in at least one selected region (for example, region 104) of body 11 to provide a plastically deformed first material segment having a first density located in a first portion of the selected region of body 11 and a second material segment having a second density lower than the first density located in an adjacent second portion of the selected region of body 11 without fracturing the insulative cellular non-aromatic polymeric material so that a predetermined insulative characteristic is maintained in body 11.

According to the present disclosure, body 11 includes localized plastic deformation that is enabled by the insulative cellular non-aromatic polymeric material in a floor-retaining flange 26 of a floor mount 17. Floor mount 17 of body 11 is coupled to a lower end of sleeve-shaped side wall 18 and to a floor 20 to support floor 20 in a stationary position relative to sleeve-shaped side wall 18 to form interior region 14 as suggested in FIG. 2. Floor mount 17 includes a floor-retaining flange 26 coupled to floor 20, a web-support ring 126 coupled to the lower end of sleeve-shaped side wall 18 and arranged to surround floor-retaining flange 26, and a connecting web 25 arranged to interconnect floor-retaining flange 26 and web-support ring 126. Connecting web 25 is configured to provide a material segment having higher first density. Connecting web-support ring 126 is configured to provide a second material segment having lower second density. Each of connecting web 25 and web-support ring 126 has an annular shape. Floor-retaining flange 26 has an annular shape. Each of floor-retaining flange 26, connecting web 25, and web-support ring 126 includes an inner layer having an interior surface mating with floor 20 and an overlapping outer layer mating with an exterior surface of inner layer as suggested in FIG. 2.

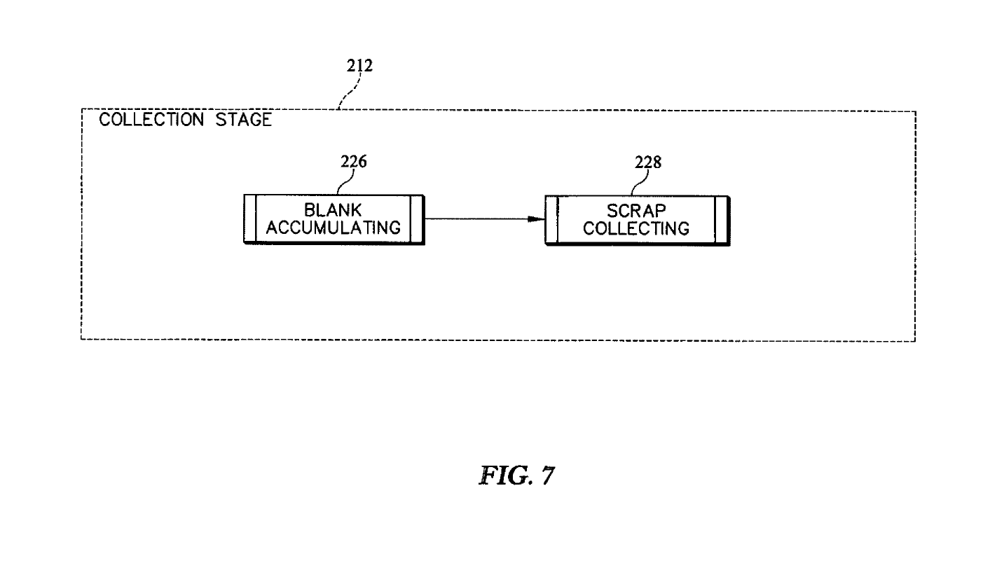

Floor 20 of insulative cup 10 includes a horizontal platform 21 bounding a portion of interior region 14 and a platform-support member 23 coupled to horizontal platform 21 as shown, for example, in FIG. 2. Platform-support member 23 is ring-shaped and arranged to extend downwardly away from horizontal platform 21 and interior region 14 into a space provided between floor-retaining flange 26 and the web-support ring 126 surrounding floor-retaining flange 26 to mate with each of floor-retaining flange 26 and web-support ring 126 as suggested in FIGS. 3 and 7.

Platform-support member 23 of floor 20 has an annular shape and is arranged to surround floor-retaining flange 26 and lie in an annular space provided between horizontal platform 21 and connecting web 25 as suggested in FIG. 2. Each of floor-retaining flange 26, connecting web 25, and web-support ring 126 includes an inner layer having an interior surface mating with floor 20 and an overlapping outer layer mating with an exterior surface of inner layer as suggested in FIG. 3 Inner layer of each of floor-retaining flange 26, web 25, and web-support ring 126 is arranged to mate with platform-support member 23 as suggested in FIG. 2.

Floor-retaining flange 26 of floor mount 17 is arranged to lie in a stationary position relative to sleeve-shaped side wall 18 and coupled to floor 20 to retain floor 20 in a stationary position relative to sleeve-shaped side wall 18 as suggested in FIGS. 2-3. Horizontal platform 21 of floor 20 has a perimeter edge mating with an inner surface of sleeve-shaped side wall 18 and an upwardly facing top side bounding a portion of interior region 14 as suggested in FIG. 2.

Insulative cellular non-aromatic polymeric material comprises, for example, a polypropylene base resin having a high melt strength, one or both of a polypropylene copolymer and homopolymer resin, and one or more cell-forming agents. As an example, cell-forming agents may include a primary nucleation agent, a secondary nucleation agent, and a blowing agent defined by gas means for expanding the resins and to reduce density. In one example, the gas means comprises carbon dioxide. In another example, the base resin comprises broadly distributed molecular weight polypropylene characterized by a distribution that is unimodal and not bimodal. Further details of a suitable material for use as insulative cellular non-aromatic polymeric material is disclosed in U.S. patent application Ser. No. 13/491,327, incorporated herein by reference.

Insulative cup 10 is an assembly comprising the body blank 500 and the floor 20. As an example, floor 20 is mated with bottom portion 24 during an article forming process 206 as suggested in FIG. 3.

Referring again to FIG. 2, top portion 22 of side wall 18 is arranged to extend in a downward direction 28 toward floor 20 and is coupled to bottom portion 24. Bottom portion 24 is arranged to extend in an opposite upward direction 30 toward rolled brim 16. Top portion 22 is curled to form rolled brim 16.

Side wall 18 is formed using a body blank 500 as suggested in FIG. 1. Body blank 500 may be produced from a strip of insulative cellular non-aromatic polymeric material, a laminated sheet, or a strip of insulative cellular non-aromatic polymeric material that has been printed on. Referring now to FIG. 1, body blank 500 is generally planar with a first side 502 and a second side (not shown). Body blank 500 is embodied as a circular ring sector with an outer arc length S1 that defines a first edge 506 and an inner arc length S2 that defines a second edge 508. Blank 500 further includes two linear edges 512 and 514. Thus, body blank 500 has two planar sides, 502 and 504, as well as four edges 506, 508, 512, and 514 which define the boundaries of body blank 500.

Fold line 516 shown in FIG. 1 is a selected region of a strip of insulative cellular non-aromatic polymeric material that has been plastically deformed in accordance with the present disclosure (by application of pressure—with or without application of heat) to induce a permanent set resulting in a localized area of increased density and reduced thickness. The thickness of the insulative cellular non-aromatic polymeric material at fold line 516 is reduced by about 50%. In addition, blank 500 is formed to include a number of depressions 518 or ribs 518 positioned between the arcuate edge 508 and fold line 516 with the depressions 518 creating a discontinuity in a surface 531. Each depression 518 is linear having a longitudinal axis that overlies a ray emanating from center 510. As discussed above, depressions 518 promote orderly forming of floor-retaining flange 26. The insulative cellular non-aromatic polymer material of reduced thickness at fold line 516 ultimately serves as connecting web 25 in the illustrative insulative cup 10. As noted above, connecting web 25 promotes folding of floor-retaining flange 26 inwardly toward interior region 14. Due to the nature of the insulative cellular non-aromatic polymeric material used to produce illustrative body blank 500, the reduction of thickness in the material at fold line 516 and depressions 518 owing to the application of pressure—with or without application of heat—increases the density of the insulative cellular non-aromatic polymeric material at the localized reduction in thickness.

Depressions 518 and fold line 516 are formed by a die that cuts body blank 500 from a strip of insulative cellular non-aromatic polymeric material, laminated sheet, or a strip of printed-insulative cellular non-aromatic polymeric material. The die is formed to include punches or protrusions that reduce the thickness of the body blank 500 in particular locations during the cutting process. The cutting and reduction steps could be performed separately, performed simultaneously, or that multiple steps may be used to form the material. For example, in a progressive process, a first punch or protrusion could be used to reduce the thickness a first amount by applying a first pressure load. A second punch or protrusion could then be applied with a second pressure load greater than the first. In the alternative, the first punch or protrusion could be applied at the second pressure load. Any number of punches or protrusions may be applied at varying pressure loads, depending on the application.

As shown in FIG. 1, depressions 518 permit controlled gathering of floor-retaining flange 26 supporting a platform-support member 23 and horizontal platform 21 of floor 20. Floor-retaining flange 26 bends about fold line 516 with fold line 516 forming connecting web 25. The absence of material in depressions 518 provides relief for the insulative cellular non-aromatic polymeric material as it is formed into floor-retaining flange 26. This controlled gathering can be contrasted to the bunching of material that occurs when materials that have no relief are formed into a structure having a narrower dimension. For example, in traditional paper cups, a retaining flange type will have a discontinuous surface due to uncontrolled gathering. Such a surface is usually worked in a secondary operation to provide an acceptable visual surface, or the uncontrolled gathering is left without further processing, with an inferior appearance. The approach of forming depressions 518 in accordance with the present disclosure is an advantage of the insulative cellular non-aromatic polymeric material of the present disclosure in that the insulative cellular non-aromatic polymeric material is susceptible to plastic deformation in localized zones in response to application of pressure (with or without application of heat) to achieve a superior visual appearance.

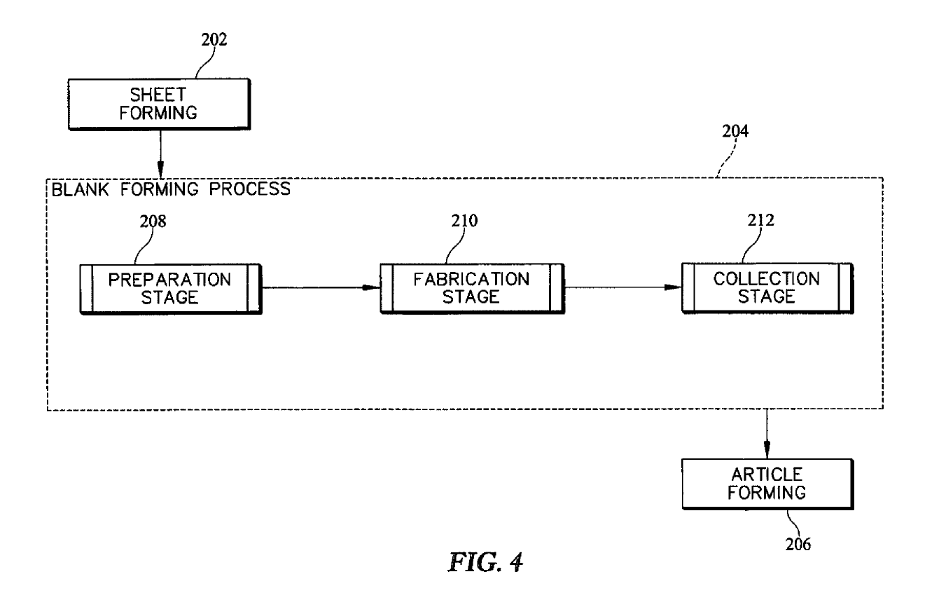

A generalization of a process 200 for forming an article, such as insulative cup 10, is shown in FIG. 3 to comprise a progression of three primary processes: a sheet forming process 202, a blank forming process 204, and an article forming process 206. The present disclosure focuses on the blank forming process 204 which may be further characterized as comprising three sub-processes: preparation stage 208, fabrication stage 210, and collection stage 212 as suggested by FIG. 4.

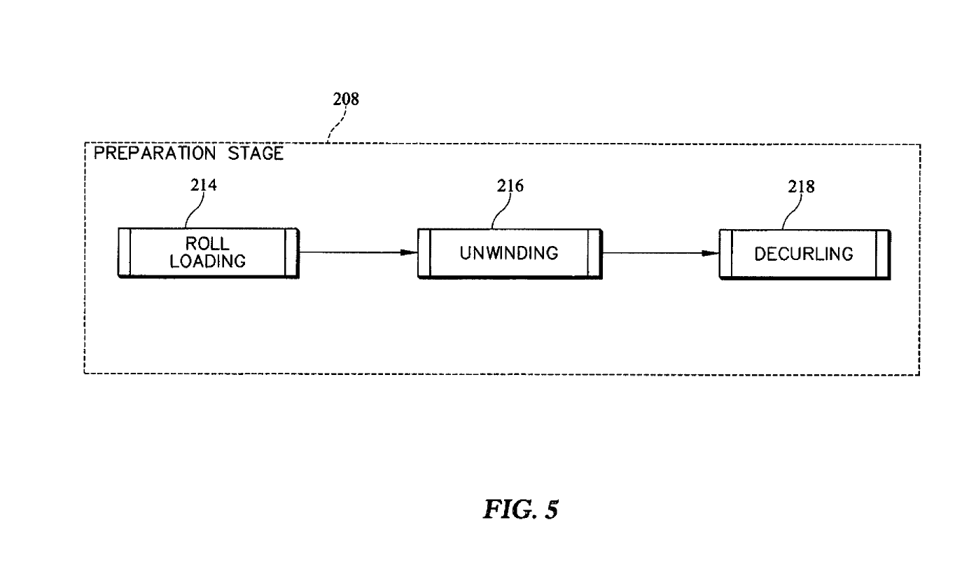

Turning now to the preparation stage 208 shown in FIG. 5, preparation stage 208 comprises a progression of roll loading 214, unwinding 216, and decurling 218. Roll loading stage 214 comprises loading a roll of insulative cellular non-aromatic polymeric material sheet that is transferred from the sheet forming process 202 onto a rack so that rolled sheet material positioned on the roll can be unwound. Unwinding 216 includes feeding the sheet material through an unwinder that controls the flow of the sheet material into the remainder of the blank forming process 204. Blank forming process 204 is a continuous process with the roll sheet material being fed through the process in a continuous progression.

After unwinding 216, the sheet material is fed to decurling 218. At decurling 218, the sheet is fed continuously through a heating process where the temperature of the sheet is raised to about 140° F. to about 190° F. or about 150° F. to about 170° F. The heating of the insulative cellular non-aromatic polymeric material sheet tends to release stresses in the skin of the material to improve the flatness of the material as it is processed and also tends to reduce creasing and wrinkling in the sheet.

After decurling 218, the sheet progresses to the fabrication stage 210 which includes a registration control step 220, an embossing step 222, and a die cutting step 224. The registration control step 220 uses a vision system to determine the position of any indicia or labeling that may be printed on the sheet in order to register the indicia with the embossing step 222 and die cutting step 224 so that the indicia is properly placed on the blank 500. At embossing step 222, a die is placed against the sheet and a force is applied to cause the embossing die to form areas of localized deformation such as, for example, the depressions 581, fold line 516, or other similar features. In the illustrative embodiment, the embossing die is heated to a temperature of between about 225° F. and 325° F. with a target of about 275° F. and is placed against the sheet for a 0.1 to 0.2 second dwell time.

In the illustrative embodiment, the sheet progresses to the die cutting step 224 where the blank 500 is separated from the sheet. In the illustrative embodiment, cutting is effective with a clearance of about 0.004 inches to about 0.014 inches. While the illustrative embodiment shows embossing and die cutting as separate processes, the die cutting step 224 and embossing step 222 may be accomplished by a single device in single action. For example, a hydraulic press may be used to apply pressure for the embossing dwell time and then add pressure to cut the blank 500 from the sheet.

Following fabrication stage 210, the collection stage 212 includes the processes of blank accumulating 226 and scrap collecting 228. In blank accumulating step 226, the blanks 500 are accumulated and packaged for movement to the article forming process 206. Sheet material that is not used for blanks 500 is collected and recycled for reuse in sheet forming process 202.

1. A blank-forming process comprising the steps of
providing a sheet including an insulative cellular non-aromatic polymeric material,
applying localized pressure to at least one area of the sheet to cause the at least one area to be plastically deformed such that it takes on a permanent set to establish a blank and scrap, and
separating the blank from the scrap.

2. The blank-forming process of claim 1, wherein applying localized pressure includes applying an external compression load.

3. The blank-forming process of claim 2, wherein applying localized pressure also includes applying heat to the at least one area of the sheet.

4. The blank-forming process of claim 3, wherein the plastic deformation does not fracture the insulative cellular non-aromatic polymeric material.

5. The blank-forming process of claim 4, wherein the plastic deformation increases a material density in the at least one area.

6. The blank-forming process of claim 1, wherein applying localized pressure includes applying an external compression load and applying heat to the at least one area of the sheet, wherein the plastic deformation does not fracture the insulative cellular non-aromatic polymeric material and the plastic deformation increases a material density in the at least one area, and wherein the insulative cellular non-aromatic polymeric material includes a base resin having a high melt strength, a polypropylene copolymer, and a cell forming agent.

7. The blank-forming process of claim 6, wherein the insulative cellular non-aromatic polymeric material further includes a homopolymer resin.

8. The blank-forming process of claim 7, wherein the base resin comprises broadly distributed molecular weight polypropylene.

9. The blank-forming process of claim 8, wherein the broadly distributed molecular weight polypropylene is characterized by a molecular weight distribution that is unimodal.

10. The blank-forming process of claim 6, wherein the plastic deformation reduces a thickness by about 50%.

11. The blank-forming process of claim 10, wherein the plastic deformation is performed in a series of progressive steps.

12. The blank-forming process of claim 11, wherein the series of progressive steps includes a first step includes applying a first pressure load to reduce the thickness by a first amount and a progressive step applies a second pressure load to reduce the thickness by a second amount.

13. The blank-forming process of claim 12, wherein the second pressure load is greater than the first pressure load.

14. The blank-forming process of claim 1, wherein applying localized pressure includes applying an external compression load and applying heat to the at least one area of the sheet, wherein the plastic deformation does not fracture the insulative cellular non-aromatic polymeric material and the plastic deformation increases a material density in the at least one area, and wherein the insulative cellular non-aromatic polymeric material includes a base resin having a high melt strength, a polypropylene homopolymer, and a cell forming agent.

15. The blank-forming process of claim 1, further comprising decurling the sheet prior to applying localized pressure.

16. The blank-forming process of claim 15, wherein decurling includes heating the sheet to about 140 degrees Fahrenheit.

17. The blank-forming process of claim 16, wherein decurling includes heating the sheet to no more than about 190 degrees Fahrenheit.

18. The blank-forming process of claim 17, wherein decurling includes heating the sheet to a temperature between about 150 degrees Farenheit and about 170 degrees Farenheit.

19. The blank-forming process of claim 1, wherein the sheet further includes indicia printed on the cellular non-aromatic polymeric material.

20. The blank-forming process of claim 19, further comprising the step of controlling registration of the indicia.

21. The blank-forming process of claim 20, wherein applying localized pressure to the at least one area of the sheet to cause the at least one area to be plastically deformed such that it takes on a permanent set includes embossing the sheet.

22. The blank-forming process of claim 21, wherein embossing the sheet includes applying pressure with a heated die.

23. The blank-forming process of claim 22, wherein the heated die has a temperature between about 225 degrees Fahrenheit and about 325 degrees Fahrenheit.

24. The blank-forming process of claim 23, wherein the heated die is applied for a dwell time of about 0.1 seconds to about 0.2 seconds.
